(19) United States
(12) Patent Application Publication
(10) Pub. No.: US 2025/0173391 A1
(43) Pub. Date: May 29, 2025

(54) METHOD AND DEVICE FOR CONVOLUTION COMPUTATION

(71) Applicant: Novatek Microelectronics Corp., Hsinchu (TW)

(72) Inventors: Chieh-Cheng Chen, Changhua County (TW); Li-Qun Weng, Miaoli County (TW); Hao-Chien Cheng, Kaohsiung City (TW)

(73) Assignee: Novatek Microelectronics Corp., Hsinchu (TW)

(21) Appl. No.: 18/669,535

(22) Filed: May 21, 2024

(30) Foreign Application Priority Data
Nov. 23, 2023 (TW) 112145277

(51) Int. Cl. G06F 17/15

(52) U.S. Cl. CPC G06F 17/15

(57) ABSTRACT

A method and a device for convolution computation are proposed. The method includes to receive input data, perform first convolution computation and second convolution computation by respectively using a first kernel and a second kernel according to the input data so as to generate plural computation results, and generate output data according to the computation results, where the size of the first kernel is different from that of the second kernel.

### CROSS-REFERENCE TO RELATED APPLICATION

This application claims the priority benefit of Taiwan application serial no. 112145277, filed on Nov. 23, 2023. The entirety of the above-mentioned patent application is hereby incorporated by reference herein and made a part of this specification.

### TECHNICAL FIELD

The disclosure relates to a method and a device for convolution computation.

### BACKGROUND

The Winograd algorithm proposes to replace a portion of multiplication computations with additional computations for convolutional layers to reduce computational complexity in a convolutional neural network (CNN). However, the Winograd algorithm results in system overhead due to additional computation of transform and inverse-transform and requires more precision for multiplication bits. Therefore, such scheme is not feasible for a programmable and flexible neural network accelerator, and its application scenario is therefore limited.

### SUMMARY OF THE DISCLOSURE

To solve the prominent issue, a method and a device for convolution computation are proposed.

According to one of the exemplary embodiments, the method includes to receive input data, perform first convolution computation and second convolution computation by respectively using a first kernel and a second kernel according to the input data so as to generate plural computation results, and generate output data according to the computation results, where the size of the first kernel is different from that of the second kernel.

According to one of the exemplary embodiments, the device includes to a processor and a memory. The memory is configured to store data. The processor is configured to receive input data, perform first convolution computation and second convolution computation by respectively using a first kernel and a second kernel according to the input data so as to generate plural computation results, and generate output data according to the computation results, where the size of the first kernel is different from that of the second kernel.

It should be understood, however, that this summary may not contain all of the aspect and embodiments of the disclosure and is therefore not meant to be limiting or restrictive in any manner. Also, the disclosure would include improvements and modifications which are obvious to one skilled in the art.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 illustrates a schematic diagram of a device for convolution computation in accordance with an exemplary embodiment of the disclosure.

FIG. 2 illustrates a flowchart of a method for convolution computation in accordance with an exemplary embodiment of the disclosure.

FIG. 3 illustrates a schematic diagram of an architecture of an improved Winograd algorithm in accordance with an exemplary embodiment of the disclosure.

FIG. 4A-FIG. 4C illustrate schematic diagrams of various modes of convolution computation in accordance with an exemplary embodiment of the disclosure.

FIG. 5A and FIG. 5B illustrate schematic diagrams of convolution computation in accordance with an exemplary embodiment of the disclosure.

FIG. 6 illustrate a schematic diagram of convolution computation in accordance with another exemplary embodiment of the disclosure.

To make the above features and advantages of the application more comprehensible, several embodiments accompanied with drawings are described in detail as follows.

### DESCRIPTION OF THE EMBODIMENTS

Some embodiments of the disclosure will now be described more fully hereinafter with reference to the accompanying drawings, in which some, but not all embodiments of the application are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout.

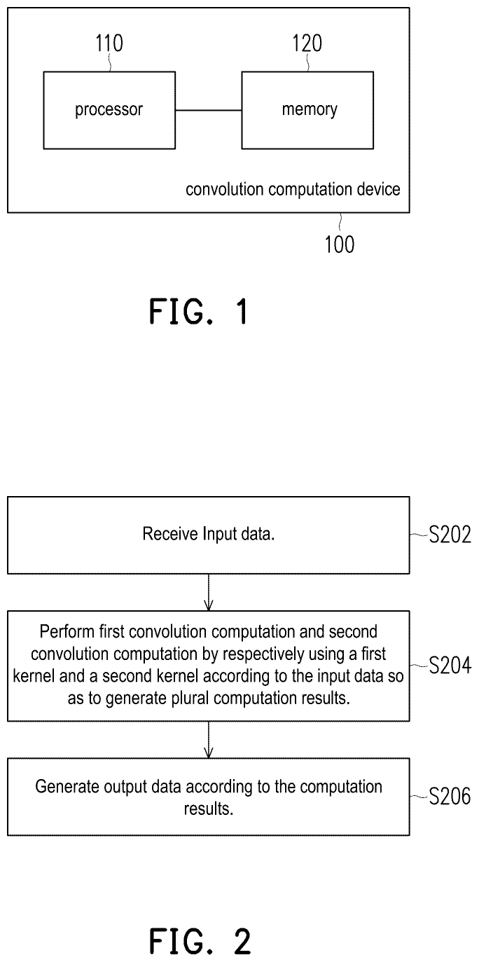

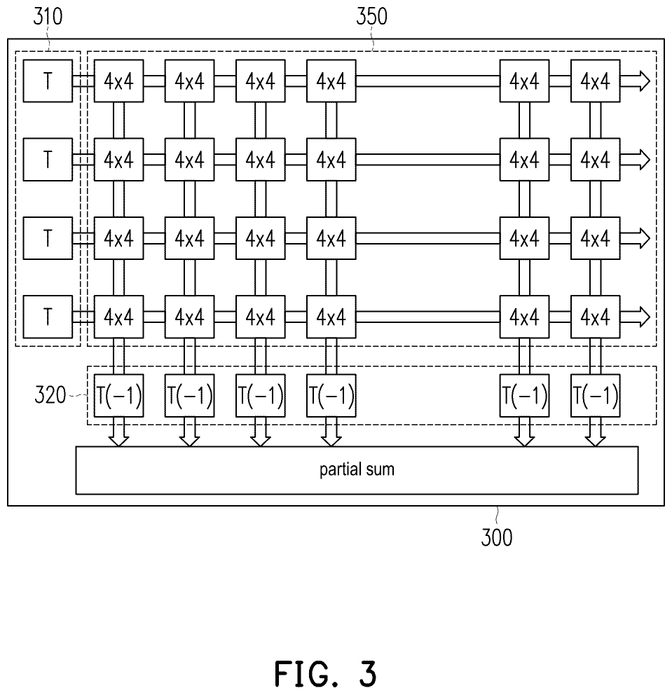

FIG. 1 illustrates a schematic diagram of a device for convolution computation in accordance with an exemplary embodiment of the disclosure. All components and configurations of the apparatus are first introduced in FIG. 1. The functionalities of the components are disclosed in more detail in conjunction with FIG. 2.

Referring to FIG. 1, a device for convolution computation 100 would at least include a processor 110 and a memory 120. The device for convolution computation 100 may be an electronic system or a computer system. The processor 110 would be configured to execute the proposed method for convolution computation and may be one or more of a central processing unit (CPU), an application processor (AP), a programmable general purpose or special purpose microprocessor, a digital signal processor (DSP), a field programmable array (FPGA), an application specific integrated circuit (ASIC), other similar devices, integrated circuits, or a combination thereof. The memory 120 would be configured to store data and may be many forms of random-access memory (RAM) such as a dynamic random-access memory (DRAM), other similar devices, integrated circuits, or a combination thereof.

FIG. 2 illustrates a flowchart of a method for convolution computation in accordance with an exemplary embodiment of the disclosure, where the steps of FIG. 2 may be implemented by the device for convolution computation 100 as illustrated in FIG. 1.

Referring to FIG. 2 in conjunction with FIG. 1, in the present exemplary embodiment, the processor 110 of the device for convolution computation 100 would receive input data (Step S202). Herein, the input data may be an original input of a CNN or an output of a previous processed layer of a current processed layer. The previous processed layer may be a convolutional layer or a pooling layer, and the current processed layer may be a convolutional layer. Note that the input data may be represented as an array.

Next, the processor 110 would perform first convolution computation and second convolution computation by respectively using a first kernel and a second kernel according to the input data so as to generate plural computation results (Step S204) and generate output data according to the computation results (Step S206), where a size of the first kernel is different from that of the second kernel.

To be specific, the sizes of the first kernel and the second kernel may be associated with their strides. Assume that the stride of the first kernel is less than that of the second kernel, then the size of the first kernel would be greater than that of the second kernel. Otherwise, the size of the first kernel would be less than that of the second kernel. For example, assume that the strides of the first kernel and the second kernel are respectively 1 and 2, then the sizes of the first kernel and the second kernel may respectively be 4×4 and 3×3.

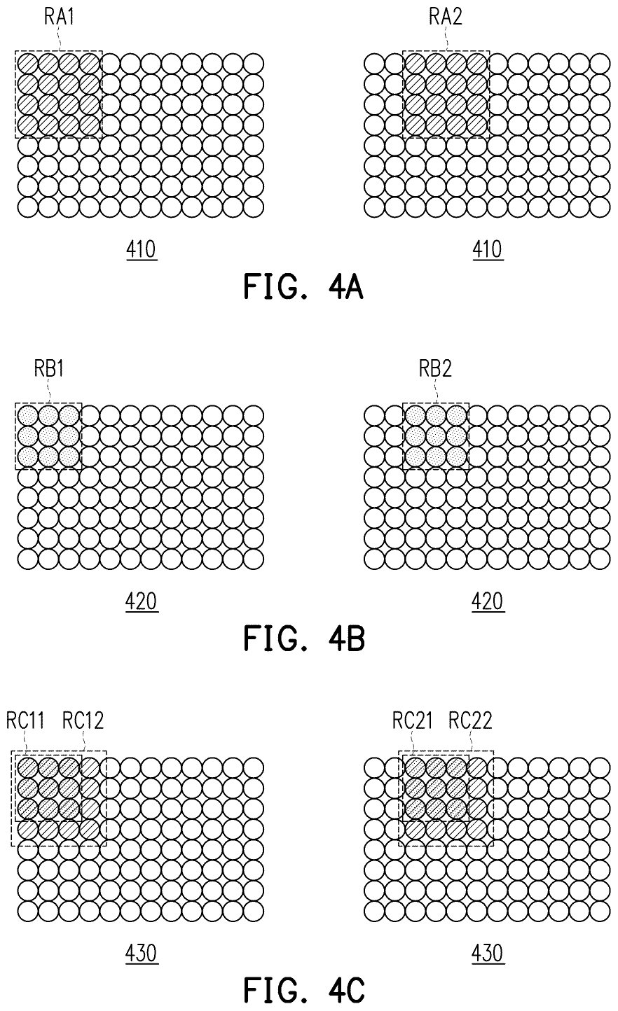

In the present exemplary embodiment, the first kernel would perform the first convolution computation by leveraging a Winograd-based algorithm. The Winograd-based algorithm may be the conventional Winograd algorithm or an improved Winograd algorithm, and the disclosure is not limited in this regard. A more comprehensive discussion on an improved Winograd algorithm would be illustrated in the following FIG. 3.

FIG. 3 illustrates a schematic diagram of an architecture of an improved Winograd algorithm in accordance with an exemplary embodiment of the disclosure.

Referring to FIG. 3, an architecture 300 would include a systolic array 350 formed by plural convolution computation units, plural transform units 310, and plural inverse-transform units 320, where the number of the transform units 310 and the number of the inverse-transform units 320 would be respectively the same as the number of input channels and the number of output channels in an convolutional layer. Differentiated from the conventional Winograd algorithm that requires to perform transform and inverse-transform respectively before and after each convolution, the improved Winograd algorithm proposes to share a transform and an inverse-transform by plural convolutions and thereby reducing system overhead.

It should be noted that, since the Winograd-based algorithm is only suitable for convolution computation with a stride being 1, such scheme is not feasible for a flexible neural network accelerator. Therefore, the second kernel in the present exemplary embodiment would perform the second convolution computation by leveraging another algorithm such as the ordinary convolution computation to provide flexibility in usage. That is, for the purpose of efficiency optimization, the first kernel that adopts the improved Winograd algorithm may be applied to a layer with a stride set to 1 to reduce computational complexity and system overhead, and the second kernel that adopts the ordinary convolution computation may be applied to a layer with 1 stride set to greater than 1 to increase usage flexibility. Details on the cooperation between two kernels would be illustrated in various exemplary embodiments as follows.

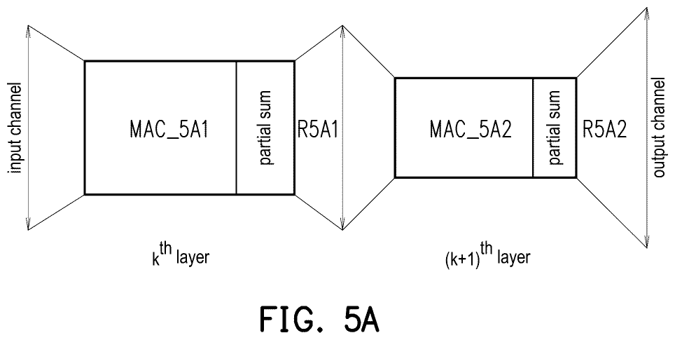

FIG. 4A-FIG. 4C illustrate schematic diagrams of various modes of convolution computation in accordance with an exemplary embodiment of the disclosure.

Referring to FIG. 4A, a kernel with a stride being 2 and a size being 4×4 would perform

convolution computation on a block RA1 of an image 410 and would further perform convolution computation on a block RA2 of the image 410. Since the size of the kernel in this example is larger, this is also referred to as “fast mode” due to a relatively larger processed area.

Referring to FIG. 4B, a kernel with a stride being 2 and a size being 3×3 would perform convolution computation on a block RB1 of an image 420 and would further perform convolution computation on a block RB2 of the image 420. Since the size of the kernel in this example is smaller, this is also referred to as “normal mode” or “slow mode” due to a relatively smaller processed area.

Referring to FIG. 4C, a kernel with a size being 4×4 and a kernel with a size being 3×3 would perform convolution computation respectively on a block RC12 and a block RC11 of an image 430 and would further perform convolution computation respectively on a block RC22 and a block RC21 of the image 430. In this example, since two kernels with different sizes are concurrently used, this is also referred to as “hybrid mode”. In other examples, two kernels may perform convolution computation sequentially on images in different consecutive convolutional layers as demonstrated hereafter.

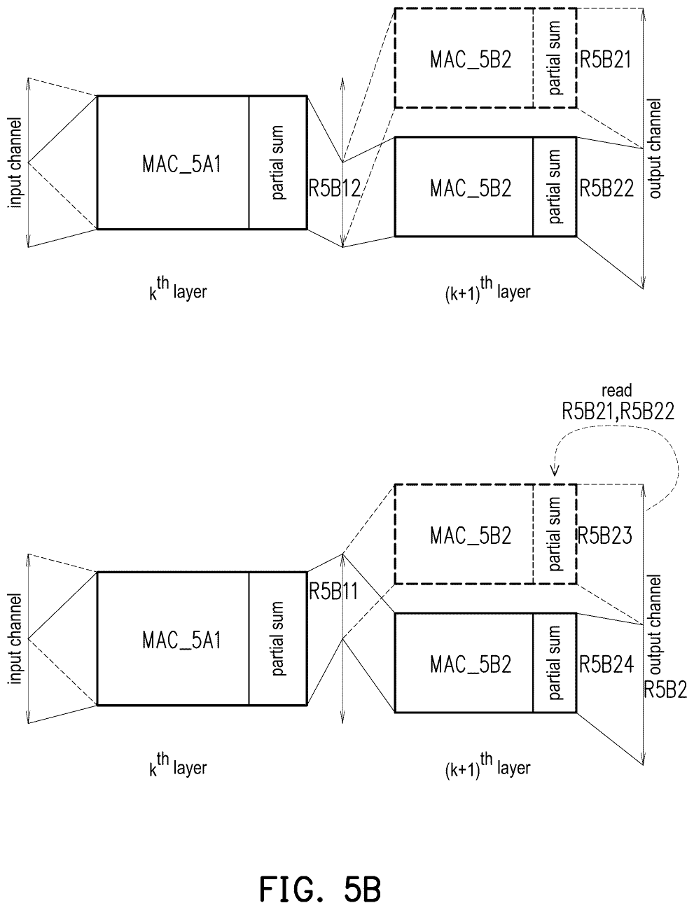

FIG. 5A and FIG. 5B illustrate schematic diagrams of convolution computation in accordance with an exemplary embodiment of the disclosure, where the processes of convolution computation in FIG. 5A and FIG. 5B may be implemented by the device for convolution computation 100. In the present exemplary embodiment, convolution computation is performed on different convolutional layers in a CNN in a hybrid mode.

Referring to FIG. 5A in conjunction with FIG. 1, the processor 110 of the device for convolution computation 100 would perform convolution computation MAC_5A1 on input data of a k^{th} layer (k is a positive integer) by using a kernel with a stride being 1 (e.g. the aforesaid first kernel leveraged by any Winograd-based algorithm) to generate a first computation result R5A1. Next, the processor 110 would set the first computation result R5A1 as input data of a (k+1)^{th} layer and perform second convolution computation MAC_5A2 on the first computation result R5A1 by using a kernel with a stride being 2 (e.g. the aforesaid second kernel leveraged by the ordinary convolution computation) to generate and set a second computation result R5A2 as output data of the (k+1)^{th} layer.

Referring to FIG. 5B in conjunction with FIG. 1, assume that an output channel of a k^{th}

layer is greater than an input channel of a (k+1)^{th} layer (e.g. the former being 8 and the latter being 4), the processor 110 would perform first convolution computation MAC_5B1 on input data of a k^{th} layer by using a kernel with a stride being 1 (e.g. the aforesaid first kernel leveraged by any Winograd-based algorithm) to generate a first computation result R5B1 and would further divide the first computation result R5B1 into plural portions (i.e. first partial computation results R5B11, R5B12).

Next, the processor 110 would perform second convolution computation MAC_5B2 on the first partial computation result R5B11 twice by using a kernel with a stride being 2 (e.g. the aforesaid second kernel leveraged by the ordinary convolution computation) to respectively generate second partial computation results R5B21, R5B22. Herein, the processor 110 may store the partial output data R5B21, R5B22 in a local memory or register. Next, the processor 110 would perform second convolution computation MAC_5B2 on the first partial computation result R5B21 twice by using the kernel with the stride being 2 to respectively generate second partial computation results R5B23, R5B24. Thereafter, the processor 110 would read the second partial computation results R5B21, RB22 from the local memory or register, sum all of the second partial output data R5B21, R5B22, R5B23, R5B24 to generate output data R5B2 of the (k+1)^{th} layer, and store the output data R5B2 in the memory 120.

In general, output data of each layer in a CNN is written into an external DRAM, and the next layer requires to read the output data of its previous layer from the external DRAM, thereby resulting in excessive accesses to the DRAM. In the present exemplary embodiment, the processor 110 would directly input a computation result of a k^{th} layer to a (k+1)^{th} layer, but not store the computation result in the memory 120. In other words, the processor 110 would only store a computation result of the (k+1)^{th} layer (e.g. the output data R5A2 or the output data R5A2) in the memory 120 to reduce accesses to the memory 120.

In the present exemplary embodiment, assume that an output channel of a (k+1)^{th} layer is n and a stride is set as 1, and computation cost would then be M/2. It should be noted that, the kernels with different sizes as proposed in the present exemplary embodiment would be suitable for a CNN having two consecutive convolutional layers with strides being set differently to perform convolution computation with high efficiency.

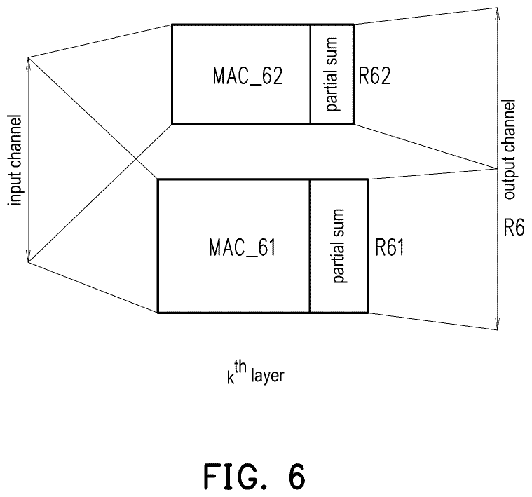

FIG. 6 illustrate a schematic diagram of convolution computations in accordance with another exemplary embodiment of the disclosure, where the processes of convolution computation in FIG. 6 may be implemented by the device for convolution computation 100. In the present exemplary embodiment, convolution computation is performed on a same convolutional layer in a CNN in a hybrid mode to optimize the utilization rate of two kernels.

Referring to FIG. 6 in conjunction with FIG. 1, the processor 110 of the device for convolution computation 100 would perform convolution computation MAC_61 on input data of a k^{th} layer by using a kernel with a fast mode (e.g. the aforesaid first kernel leveraged by any Winograd-based algorithm) to generate a first computation result R61. Concurrently, the processor 110 would perform convolution computation MAC_62 on the input data of the k^{th} layer by using a kernel with a slow mode (e.g. the aforesaid second kernel leveraged by the ordinary convolution computation) to generate a second computation result R62. Thereafter, the processor 110 would combine the first computation result R61 and the second computation result R62 to generate output data R6 of the k^{th} layer.

In addition, in one exemplary embodiment, the processor 110 may individually and/or collectively perform quantization on all the output data and the computation results in the aforesaid exemplary embodiments to reduce storage bits for the purpose of saving memory.

In view of the foregoing, the disclosure proposes two kernels with different sizes to enhance computation efficiency. Therefore, the prominent issue of a fast convolution algorithm being lack of flexibility in usage can be remedied, bandwidth and memory requirements can be further reduced.

No element, act, or instruction used in the detailed description of disclosed embodiments of the present application should be construed as absolutely critical or essential to the present disclosure unless explicitly described as such. Also, as used herein, each of the indefinite articles “a” and “an” could include more than one item. If only one item is intended, the terms “a single” or similar languages would be used. Furthermore, the terms “any of” followed by a listing of a plurality of items and/or a plurality of categories of items, as used herein, are intended to include “any of”, “any combination of”, “any multiple of”, and/or “any combination of multiples of the items and/or the categories of items, individually or in conjunction with other items and/or other categories of items. Further, as used herein, the term “set” is intended to include any number of items, including zero. Further, as used herein, the term “number” is intended to include any number, including zero.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A method for convolution computation comprising:
receiving input data;
performing first convolution computation and second convolution computation by respectively using a first kernel and a second kernel according to the input data so as to generate a plurality of computation results, wherein a size of the first kernel is different from that of the second kernel; and
generating output data according to the plurality of computation results.

2. The method according to claim 1,
wherein the size of the first kernel is greater than that of the second kernel, and
wherein a stride of the first kernel is less than that of the second kernel.

3. The method according to claim 2,
wherein the first kernel performs the first convolution computation by leveraging a Winograd algorithm, and
wherein the second kernel performs the second convolution computation by leveraging another algorithm different from the Winograd algorithm.

4. The method according to claim 3,
wherein the stride of the first kernel is 1, and
wherein the stride of the second kernel is greater than 1.

5. The method according to claim 1, wherein the step of performing the first convolution computation and the second convolution computation by respectively using the first kernel and the second kernel according to the input data so as to generate the plurality of computation results comprises:
performing the first convolution computation on the input data by using the first kernel to generate a first computation result; and
performing the second convolution computation on the first computation result by using the second kernel to generate a second computation result.

6. The method according to claim 5, wherein the step of generating the output data according to the plurality of computation results comprises:
setting the second computation result as the output data.

7. The method according to claim 1, wherein the step of performing the first convolution computation and the second convolution computation by respectively using the first kernel and the second kernel according to the input data so as to generate the plurality of computation results comprises:
performing the first convolution computation on the input data by using the first kernel to generate a first computation result, wherein the first computation result comprises a plurality of first partial computation results; and
performing the second convolution computation respectively on each of the plurality of first partial computation results by using the second kernel to generate a plurality of second partial computation results.

8. The method according to claim 7, wherein the step of generating the output data according to the plurality of computation results comprises:
summing each of the plurality of second partial computation results, and setting a summation of the plurality of second partial computation results as the output data.

9. The method according to claim 1, wherein the step of performing the first convolution computation and the second convolution computation by respectively using the first kernel and the second kernel according to the input data so as to generate the plurality of computation results comprises:
performing the first convolution computation on first input data of the input data by using the first kernel to generate a first computation result; and
performing the second convolution computation on second input data of the input data by using the second kernel to generate a second computation result.

10. The method according to claim 9, wherein the step of generating the output data according to the plurality of computation results comprises:
combining the first computation result and the second computation result, and setting the combined first computation result and second computation result as the output data.

11. The method according to claim 1 further comprising:
not storing the plurality of computation results in a memory; and
storing the output data in the memory.

12. A device for convolution computation comprising:
a memory, configured to store data; and
a processor, configured to:
receive input data;
perform first convolution computation and second convolution computation by respectively using a first kernel and a second kernel according to the input data so as to generate a plurality of computation results, wherein a size of the first kernel is different from that of the second kernel; and
generate output data according to the plurality of computation results.

13. The device according to claim 12,
wherein the size of the first kernel is greater than that of the second kernel, and
wherein a stride of the first kernel is less than that of the second kernel.

14. The device according to claim 13,
wherein the first kernel performs the first convolution computation by leveraging a Winograd algorithm, and
wherein the second kernel performs the second convolution computation by leveraging another algorithm different from the Winograd algorithm.

15. The device according to claim 12,
wherein the processor does not store the plurality of computation results in the memory, and
wherein the processor stores the output data in the memory.
